(19) United States
(12) Patent Application Publication
(10) Pub. No.: US 2006/0124893 A1
(43) Pub. Date: Jun. 15, 2006

(54) Solvent extraction mixture for the separation of groups of base metals

(76) Inventors: Jozef Marie Schaekers, Randburg (ZA); Jan Gysbert Hermanus DuPreez, Port Elizabeth (ZA)

Correspondence Address: BRINKS HOFER GILSON & LIONE, P.O. BOX 10395, CHICAGO, IL, 60610, US

(21) Appl. No.: 10/733,907

(22) Filed: Dec. 11, 2003

(30) Foreign Application Priority Data
Dec. 19, 2002 (WO) PCT/ZA02/00096
Jun. 13, 2001 (ZA) 01/4794

(51) Int. Cl. H01M 4/88

(52) U.S. Cl. 252/182.1

(57) ABSTRACT

An organic solvent extraction mixture which includes a first extractant which is a substituted imidazole or benzimidazole, a non-selective strongly acidic cation second extractant, such as a sulphonic acid (R—SO₃H), to facilitate phase transfer of base metal ions from an aqueous weakly acidic sulphate solution into the organic phase, a modifier to improve the characteristics of the organic, phase with respect to metal complex solubility to avoid third phase formation, completeness and ease of stripping, viscosity and phase disengagement, and a diluent.

This application claims priority from PCT/ZA02/0096 published in English on Dec. 19, 2002 as WO 02/101182, which itself claims priority from ZA 01/4794 filed 13 Jun. 2001, the entire contents of each are incorporated herein by reference.

This invention relates to a mixture of organic compounds suitable for the solvent extraction-based separation of base metals and associated impurities from weakly acidic sulphate solutions.

Hydrometallurgical methods to recover base metals from ores, concentrates or intermediates have increased in popularity due to the perceived reduced environmental impact in comparison with smelting operations. Their application is frequently hindered by the lack of suitable methods for the selective recovery of the metals of interest in a pure form.

Acidic sulphate solutions could be obtained by direct acid leaching of processing residues, ores or concentrates containing oxides and/or secondary sulphides of base metals. They could also be obtained by treating similar but more refractory materials by low pressure oxidation (Activox process), standard pressure oxidation or bioleaching of sulphides, or high temperature acid leaching of refractory oxide ores.

The resulting aqueous sulphate solution, which could also contain other anions such as chloride and nitrate, mostly contains the base metals Cu, Ni, Co, Zn, Cd and Pb, additional impurities such as Mn, Fe (II), Fe (III), and the alkaline earth metals Ca and Mg, their relative concentrations depending on the ore/intermediate being treated.

The removal of appreciable amounts of copper from such solutions can be effected by selective cementation with scrap iron or by solvent extraction (SX) with hydroxy-oxime based extractants (LIX-extractants).^{(1,2)} In both instances, the presence of ferric ions in the leach solution will affect the efficiency of the downstream recovery process and its efficient removal is highly recommended but not always readily achieved, not even with hydroxy-oxime based extractants.

Pregnant solutions obtained by leaching zinc oxide ores or roasted sulphide concentrates or direct bioleaching of sulphides, are traditionally treated by a combination of neutralisation/precipitation and cementation to remove undesirable impurities such as Fe, Ni, Co, Cu, Cd and Pb before electrowinning (EW).⁽³⁻⁷⁾ This is normally associated with appreciable losses of zinc. More recently, SX has also been used as a means of purifying the primary leach liquor with the added advantage that the zinc content of the pregnant liquor can be increased to suit subsequent EW requirements.

The preferred extractant appears to be di-2-ethyl hexyl phosphoric acid (DEHPA) which is not very selective for zinc and tends to co-extract impurities such as Fe, Al, Pb, Cd and Ca if a raffinate with a low zinc content is required.^{(8,9)}

Treatment of nickel/cobalt pregnant solutions tends to be more complicated. The main impurities in such solutions are typically Fe, Mn, Ca, Mg, Cu and, to a lesser extent, Zn. The separation of nickel and cobalt can readily be effected with a SX reagent such as bis(2,4,4-triethylpentyl)-phosphinic acid (CYANEX 272), but this does not offer the opportunity of removing impurities as required for the subsequent EW process.⁽¹⁰⁻¹³⁾

Various strategies have been developed to effect the purification and separation required to obtain high purity products in the form of salts, oxides or metals.

In the more traditional downstream treatment procedure, the weakly acidic sulphate solution is treated with sulphide to selectively precipitate the base metals and effect removal of other dissolved impurities, mainly Mn, Ca, Mg and other alkaline earth or alkali metals.⁽¹³⁻¹⁵⁾ The main disadvantage of this option is that the precipitate needs to be redissolved by pressure oxidation before further purification and separation of cobalt and nickel can be considered.

In an alternative option, the base metals are precipitated as hydroxides by neutralising the solution with MgO or CaO.⁽¹⁶⁻²¹⁾ The main advantage of this procedure is that the base metals in the precipitate can be re-leached in ammonia, ammonium sulphate or ammonium carbonate solutions at atmospheric pressure. The main disadvantage, in comparison with sulphide precipitation, is that rejection of manganese and the alkaline earth metals is less efficient as they tend to coprecipitate with the base metals. They are, however, largely insoluble during releaching but the presence of manganese tends to cause incomplete recovery of nickel and cobalt necessitating an additional strong acid leaching stage to prevent losses of these metals.

Further potential solutions are based on SX only, eventually after removal of Fe, Al and Cr by neutralisation/precipitation.

In one proposed option, base metals are selectively extracted from strongly acidic solutions with a di-thiophosphinic acid commercial extractant (CYANEX 301) leaving Ca, Mg and Mn in the raffinate. Subsequently, the base metals are stripped from the organic phase for further separation and purification.⁽²²⁾

Other systems, under investigation or proposed, usually involve the use of a carboxylic acid (typically Versatic acid), a di-alkyl phosphoric acid (DEHPA) and CYANEX 272 in various configurations.^{(10-12, 21)} In these instances, Versatic acid is mainly used to remove the majority of Mn, Ca and Mg without major losses of base metals, but does not offer any possibility of separating any of the base metals. It also has the disadvantage of high water solubility at the elevated pH required for effective nickel/cobalt recovery.

Better rejection of the unwanted impurities, and especially calcium and manganese, can be obtained by adding a synergistic compound to the Versatic acid-containing extraction mixture with an associated reduced pH for effective nickel/cobalt extraction as an added advantage.⁽²³⁻²⁶⁾ As an alternative, a second extraction can be done on the acidic solution, obtained by stripping the loaded Versatic acid mixture, with a DEHPA based extraction mixture to remove further amounts of calcium and manganese with the added advantage of also removing Zn, Pb, Cd and Cu if present.^{(26,27)} However, the use of SX to remove trace amounts of impurities is usually not very cost effective. In addition, extreme care must be taken to avoid losses of nickel/cobalt during this step.

CYANEX 272 is typically used to separate cobalt and nickel, either before or after partly removing Ca, Mg and Mn impurities using Versatic acid mixtures. However, other base metals, if still present, are co-extracted and special techniques, such as selective stripping, are required to obtain an impurity-free solution suitable to produce a high purity product.

From the preceding observations it is clear that an extraction mixture capable of simplifying the procedure to obtain purified base metal sulphate solutions, suitable to be converted to high purity products, will be of great benefit to the industry as it will reduce the complexity of the processes and the associated costs.

### OBJECT OF THE INVENTION

It is an object of the invention to provide a mixture of organic compounds which is suitable to be used as a solvent extractant to treat acidic sulphate solutions and which is capable of:

a) selectively rejecting unwanted impurities including manganese, lead, alkaline earth metals, alkali metals and ammonium ions,

b) selectively extracting groups of certain base metals by direct extraction or by differential stripping or by a combination of these, and

c) selectively removing single base metals by direct extraction or by differential stripping.

### SUMMARY OF THE INVENTION

The invention provides an organic solvent extraction mixture which includes:

(a) a first extractant, which is a substituted imidazole (Diagram 1) or benzimidazole (Diagram 2): 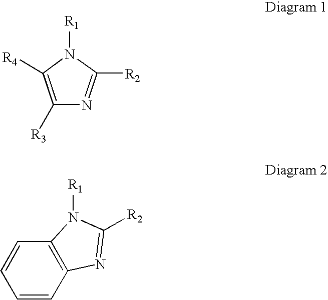
and wherein the substituents are:
—R₁=an organic group which:
   is branched or unbranched;
   is saturated or partly unsaturated;
   contains aromatic groups or not;
   is with or without other functional groups; or
   is an esterified fatty acid group;
and wherein R₁ may have between 2 and 20 carbon atoms and preferably has between 6 and 15 carbon atoms;
—R₂=hydrogen or a methyl group, preferably hydrogen;
—R₃=hydrogen or a short chain organic group with 1 or 2 carbon atoms, preferably hydrogen or a methyl group; and
—R₄=hydrogen or a short chain organic group with 1 or 2 carbon atoms, preferably hydrogen or a methyl group;

b) a non-selective strongly acidic cation second extractant, such as a sulphonic acid (R—SO₃H), to facilitate phase transfer of base metal ions from aqueous weakly acidic sulphate solution into the organic phase, and wherein R is an aliphatic group, either saturated or unsaturated and branched or unbranched, an aromatic organic group or a mixed group consisting of aliphatic and aromatic parts, with between 3 and 40 carbon atoms, preferably with between 8 and 30 carbon atoms;

c) a modifier to improve the characteristics of the organic phase with respect to metal complex solubility to avoid third phase formation, completeness and ease of stripping, viscosity and phase disengagement; and

d) a diluent, which is selected from non-specific aliphatic or aromatic or partly aliphatic, partly aromatic mixtures of unspecified composition with a moderate boiling point range and a suitable flash point, such as Kerosene, Shellsol (various grades), Escaid (various grades), Solvesso and similar products.

The concentration of the first extractant can be between 0.01 and 1.50 Molar, depending on the capacity required and preferably is between 0.25 and 1.50 Molar for commercial applications.

Typical examples of the second extractant include: d-nonyl naphthalene sulphonic acid (DNNS), d-dodecyl naphthalene sulphonic acid, di-n-octyl methyl sulphonic acid and alkyl-substituted benzene sulphonic acid which are commercially available or easy to synthesize.

The concentration of this second extractant may be between 0.001 to 1.0 Molar sulphonic acid, preferably between 0.05 to 0.6 Molar, the optimum being 10% to 25% of the extractant concentration and 40% to 100% of the maximum metal molarity in the organic phase.

The modifier is preferably characterized by the presence of a sterically available oxygen or nitrogen atom with lone pairs of electrons as in phenols, alcohols, esters of inorganic and organic acids, ketones, aldehydes, ethers, organic acids, amines and amides.

The modifier may be added at a concentration of from 20% to 75% and preferably at a concentration of 30% to 70% of the total mixture.

The diluent can be added at a concentration sufficient to make up a total of 100% for the mixture.

Extractions can be carried out in the temperature range between 10° C. and 70° C. and preferably between ambient and 45° C.

The aqueous pregnant feed solution to be treated can also contain moderate amounts of non-complexing cations, such as nitrate, chlorate or perchlorate, and also appreciable amounts of chloride up to a concentration of 3 Molar.

Extractions can be carried out at an aqueous pH between 0.0 and 6.0, the preferred pH depending on the objective of the extraction process. This value can readily be estimated from the results given in the Examples by those skilled in the art of solvent extraction-based separations.

Stripping of the organic phase can readily be effected with a dilute aqueous sulphuric acid solution at a concentration equal to or slightly higher than the change in the metal concentration in the aqueous strip solution during the stripping process.

### BRIEF DESCRIPTION OF THE DRAWINGS

The invention is further described by way of examples with reference to the accompanying drawings in which:

FIGS. 1, 2 and 3 are flow diagrams of different standard solvent extraction processes, and

FIGS. 4 to 11 are curves of extraction efficiency as a function of pH for different extractants, with FIGS. 6 to 11 relating to extractants according to the invention.

### DESCRIPTION OF PREFERRED EMBODIMENTS

The invention can be applied using any standard solvent extraction apparatus consisting of an extraction section and a single or double stripping action, with an optional washing or scrubbing section in between, and suitable to simulate standard solvent extraction processes as shown in any of the flow sheets in FIGS. 1 to 3 respectively.

The flow sheets shown in FIGS. 1 to 3 are largely self-explanatory and are known in the art. They are therefore not described in detail hereinafter.

In the following Examples a comparison is made of the results obtained by using organic solvent extractant mixtures according to the invention and the results obtained using other extractants. Examples 1 and 2 relate to the use of organic extraction mixtures which do not fall inside the scope of the invention while the remaining Examples illustrate results obtained using organic extraction mixtures which fall within the scope of the invention.

### EXAMPLE 1

Aqueous solutions of individual metal sulphate salts, at 0.001 Molar, were contacted with an organic mixture containing 0.02 Molar DNNS in an iso-decanol (30%)—Shellsol A mixture at an A:O ratio of 1:1. The pH of the aqueous phase was adjusted to the target value using either aqueous sulphuric acid or sodium hydroxide solutions. The residual metal concentration in the aqueous phase was determined to calculate the % extraction. Occasionally, the organic phase was contacted with aqueous 1.0 Molar sulphuric acid to strip the metals. The recovered metal in the strip solution was then also determined to calculate and verify the % extraction. The results in FIG. 4 indicate that DNNS is a non-selective extractant for divalent cations with optimum extraction in the pH range 1.00 to 3.0.

### EXAMPLE 2

Aqueous solutions of individual metal sulphate salts, at 0.001 Molar, were contacted with an organic mixture containing 0.1 Molar 1-decylimidazole (DIMZ) in an iso-decanol (70%)—Shellsol A mixture at an A:O ratio of 1:1. The pH of the aqueous phase was adjusted to the target value using either aqueous sulphuric acid or sodium hydroxide solutions. The residual metal concentration in the aqueous phase was determined to calculate the % extraction. Occasionally, the organic phase was contacted with aqueous 1.0 Molar sulphuric acid to strip the metals. The recovered metal in the strip solution was then also determined to calculate and verify the % extraction. The results in FIG. 5 indicate that, with DIMZ only present, only copper is extracted and only to a limited extent even in the presence of a large excess of extractant.

### EXAMPLE 3

Aqueous solutions of individual metal sulphate salts, at 0.001 Molar, were contacted with an organic mixture containing 0.1 Molar 1-decylimidazole (DIMZ) and 0.007 Molar DNNS in an iso-decanol (70%)—Shellsol A mixture at an A:O ratio of 1:1. The pH of the aqueous phase was adjusted to the target value using either aqueous sulphuric acid or sodium hydroxide solutions. The residual metal concentration in the aqueous phase was determined to calculate the % extraction. Occasionally, the organic phase was contacted with aqueous 1.0 Molar sulphuric acid to strip the metals. The recovered metal in the strip solution was then also determined to calculate and verify the % extraction.

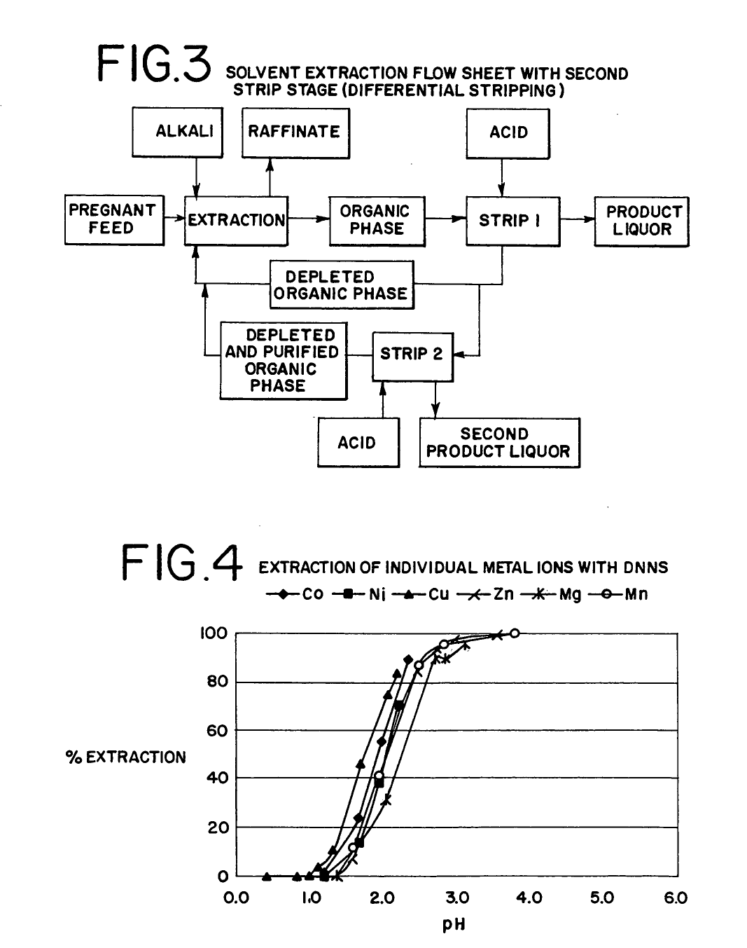

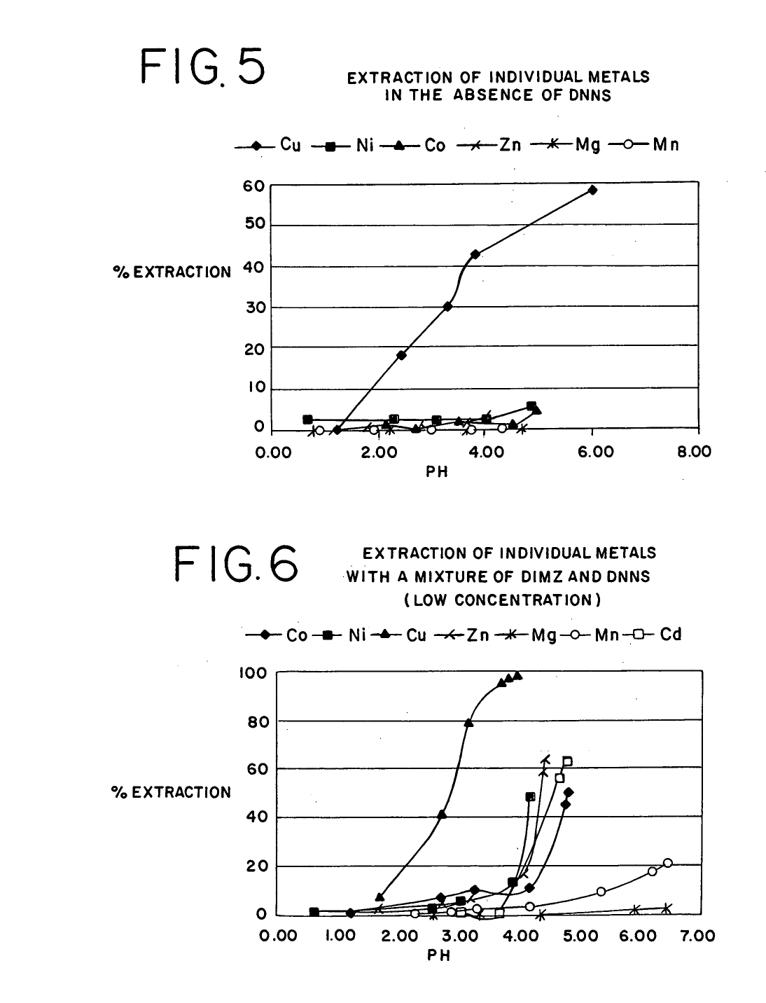

The results in FIG. 6 indicate that, with both DIMZ and DNNS present, copper is extracted at a pH of ˜3.0 and the other base metals at a pH around 4.0. Mg and Mn are hardly extracted even at pH 6.0. From this it is evident that manganese and magnesium could be removed from a mixed sulphate solution according to the flow sheet given in FIG. 1. Similarly, copper could be removed according to the flow sheet given in FIG. 3.

### EXAMPLE 4

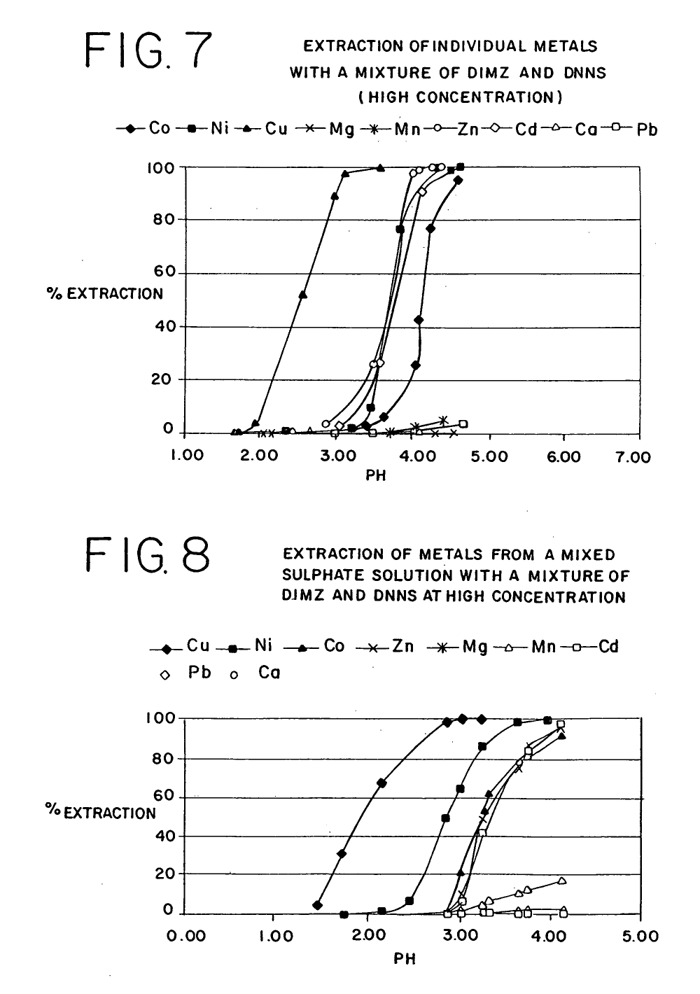

Aqueous solutions of individual metal sulphate salts, at 0.025 Molar, were contacted with an organic mixture containing 1.5 Molar 1-decylimidazole (DIMZ) and 015 Molar DNNS in iso-decanol (no other diluent) at an A:O ratio of 1:1. The pH of the aqueous phase was adjusted to the target value using either aqueous sulphuric acid or sodium hydroxide solutions. The residual metal concentration in the aqueous phase was determined to calculate the % extraction. Occasionally, the organic phase was contacted with aqueous 1.0 Molar sulphuric acid to strip the metals. The recovered metal in the strip solution was then also determined to calculate and verify the % extraction. The results in FIG. 7 indicate that, with both DIMZ and DNNS present at high concentration, copper is extracted at a pH of ˜2.5 and the other base metals at a pH around 3.5, which are about 0.5 pH units lower than the values found in Example 3. Mg, Ca, Pb and Mn are hardly extracted even at pH 5.0.

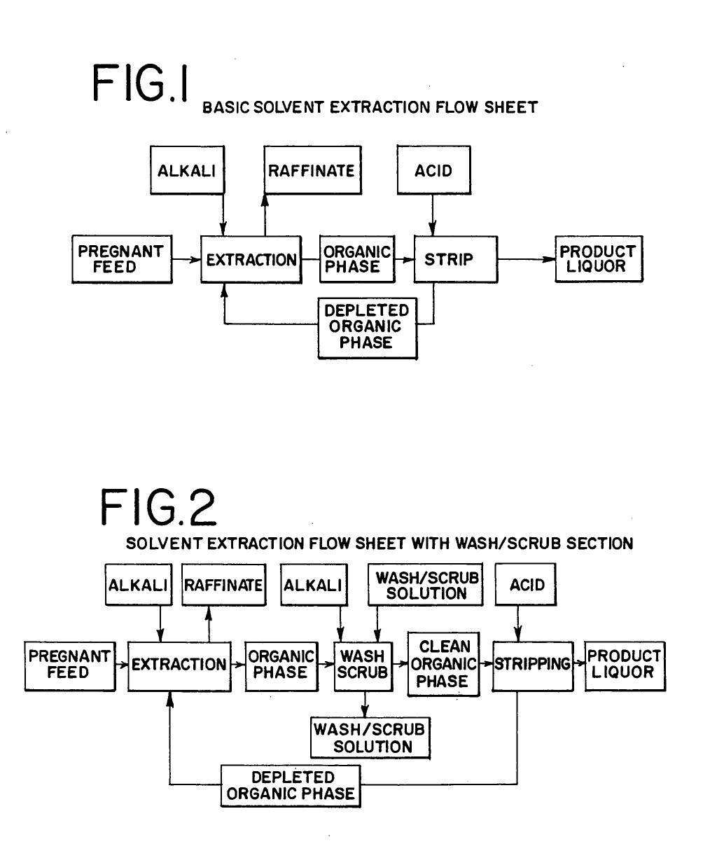

From this it is evident that manganese, lead, calcium and magnesium could be removed from a mixed sulphate solution according to the flowsheet given in FIG. 1. Similarly, copper could be removed according to the flowsheet given in FIG. 3. The difference in the extraction pH for nickel and cobalt is small, but large enough to allow selective extraction of nickel from cobalt, if the concentration of the latter is relatively small, according to the flowsheet given in FIG. 2.

### EXAMPLE 5

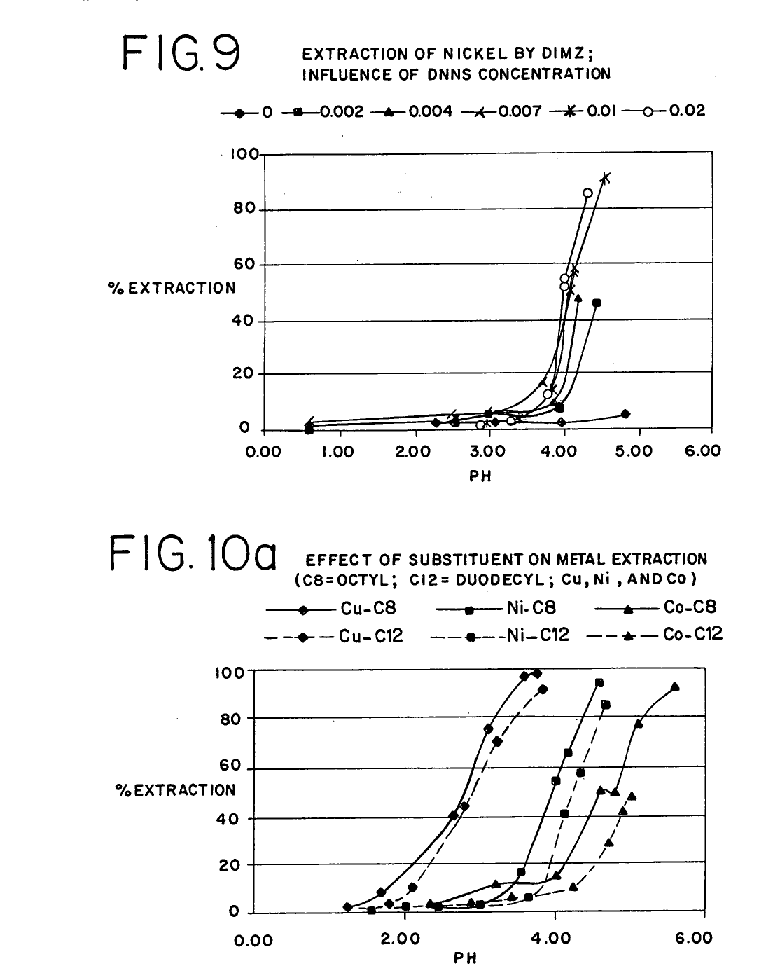

An aqueous solution of metal sulphates, obtained by bioleaching a nickel sulphide concentrate, after removal of dissolved iron, containing Ni (1.27 g/l), Cu (3.94 ppm), Co (17.3 ppm), Mg (118 ppm), Mn (2.26 ppm) and Zn (0.66 ppm) was contacted with an organic mixture containing 1.5 Molar 1-decylimidazole (DIMZ) and 0.15 Molar DNNS in iso-decanol (70%). The pH of the aqueous phase was adjusted to the target value using either aqueous sulphuric acid or sodium hydroxide solutions. The residual metal concentration in the aqueous phase was determined to calculate the % extraction. Occasionally, the organic phase was contacted with aqueous 1.0 Molar sulphuric acid to strip the metals. The recovered metal in the strip solution was then also determined to calculate and verify the % extraction. The results in FIG. 8 indicate that extraction of the metals present in the mixture is very similar to their extraction from single metal sulphate solutions (Example 4, FIG. 7). However, the extraction of zinc and cadmium, which are only present at very low concentrations, is shifted to higher pH values to coincide with the extraction of cobalt. Mg, Mn, Ca and Pb are hardly extracted even at pH 4.0, when extraction of the other metals is virtually complete.

From this it is evident that manganese, lead, calcium and magnesium could be removed from a mixed sulphate solution according to the flowsheet given in FIG. 1. Similarly, copper could be removed from other base metals according to the flowsheet given in FIG. 3. The difference in the extraction pH for nickel and cobalt, cadmium or zinc is small, but large enough to allow selective extraction of nickel from these elements by including an effective scrub section according to the flowsheet given in FIG. 2.

### EXAMPLE 6

An aqueous solution of nickel sulphate, at 0.001 Molar, was contacted with an organic mixture containing 0.1 Molar 1-decylimidazole (DIMZ) and different concentrations of DNNS in an iso-decanol (70%)—Shellsol A mixture at an A:O ratio of 1:1. The pH of the aqueous phase was adjusted to the target value using either aqueous sulphuric acid or sodium hydroxide solutions. The residual metal concentration in the aqueous phase was determined to calculate the % extraction. Occasionally, the organic phase was contacted with aqueous 1.0 Molar sulphuric acid to strip the metals. The recovered metal in the strip solution was then also determined to calculate and verify the % extraction.

The results in FIG. 9 indicate that, without DNNS present, nickel is hardly extracted even at a pH of 4.9. Effective nickel extraction is already achieved at a DNNS concentration of 0.002 Molar. Nickel extraction improves only marginally with a further increase in DNNS concentration, although the extraction curves are steeper, which is an advantage when separating metals with similar extractability. A large excess of DNNS, up to 0.020 Molar for 0.001 Molar metal concentration, does not affect the extraction adversely.

### EXAMPLE 7

Aqueous solutions of individual metal sulphate salts, at 0.001 Molar, were contacted with an organic mixture containing 0.1 Molar N-substituted imidazole (N-octylimidazole, N-decylimidazole and N-duodecylimidazole) and 0.010 Molar DNNS in an iso-decanol (70%)—Shellsol A mixture at an A:O ratio of 1:1. The pH of the aqueous phase was adjusted to the target value using either aqueous sulphuric acid or sodium hydroxide solutions. The residual metal concentration in the aqueous phase was determined to calculate the % extraction. Occasionally, the organic phase was contacted with aqueous 1.0 Molar sulphuric acid to strip the metals. The recovered metal in the strip solution was then also determined to calculate and verify the % extraction.

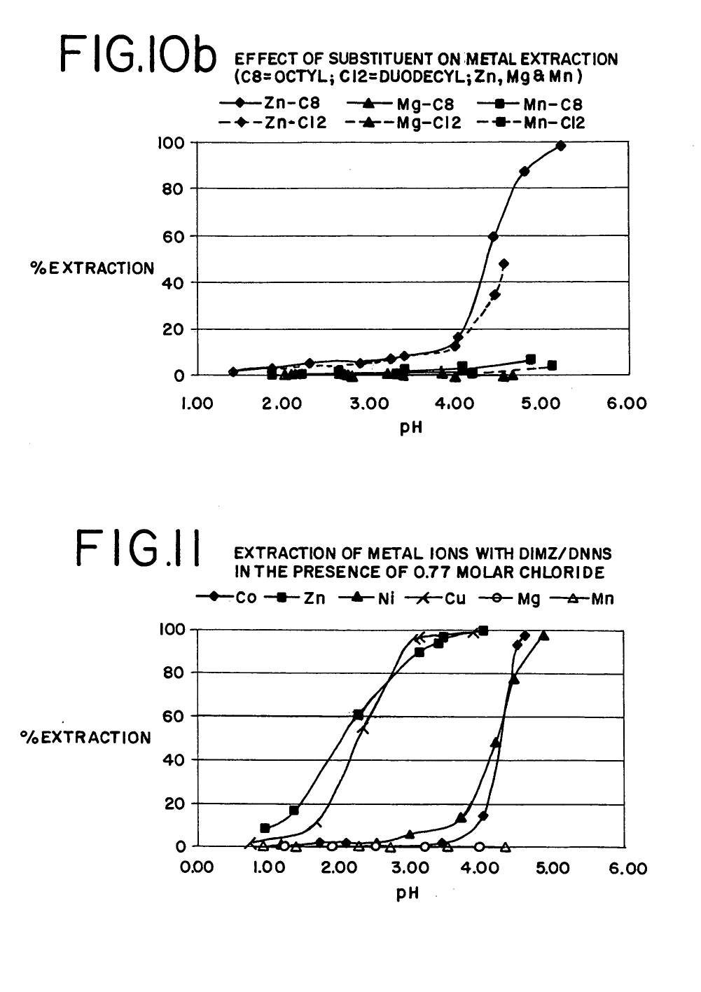

The results in FIGS. 10a and 10b, together with those from Example 3 (FIG. 6), indicate that the extraction of the various metals is hardly affected by the substituent group, although the extraction is slightly weaker with N-duodecyl imidazole.

### EXAMPLE 8

Aqueous solutions of individual metal sulphate salts, at 0.001 Molar, containing also chloride at a concentration of 0.77 Molar, were contacted with an organic mixture containing 0.1 Molar 1-decylimidazole (DIMZ) and 0.010 Molar DNNS in an iso-decanol (70%)—Shellsol A mixture at an A:O ratio of 1:1. The pH of the aqueous phase was adjusted to the target value using either aqueous sulphuric acid or sodium hydroxide solutions. The residual metal concentration in the aqueous phase was determined to calculate the % extraction. Occasionally, the organic phase was contacted with aqueous 1.0 Molar sulphuric acid to strip the metals. The recovered metal in the strip solution was then also determined to calculate and verify the % extraction.

The results in FIG. 11, together with those from Example 3 (FIG. 6), indicate that the extraction of zinc is strongly enhanced by the presence of chloride in the aqueous phase. The extraction of copper and cobalt is only slightly enhanced and that of nickel is not affected at all. The extractability of magnesium and manganese remains low and is even weaker if chloride is present.

The results show that the presence of chloride, either due to circumstances or by design, is advantageous for the selective separation of certain groups of base metals such as Cu/Zn and Ni/Co from each other and each from the non-extractable impurities.

### REFERENCES

1- J Szymanowski, “Hydroxyoximes and Copper Hydrometallurgy”, CRC Press, Boca Raton, USA, 1993.
2- S C Das, P G Krishna, “Effect of Fe (III) during Copper Electrowinning at Higher Current Density”, Int. J. Miner. Process., 46,1996, pp 91.
3- K Tanabe, T Ohgai, T Akiyama and H Fukushima, “Characteristic Behavior of Iron-Group Metals in the Purification Process using Zinc Dust”, Proceedings “Zinc & Lead '95”, 22-24 May 1995, Sendai, Japan, pp 303.
4- K Tozawa, T Nishimura, M Akahori, M A Malaga, “Comparison between Purification Process for Zinc Leach Solutions with Arsenic and Antimony Trioxides”, Hydrometallurgy, 30, 1992, pp 445-461.
5- M E Chalkley, M J Collins, I M Masters and E Ozberk, “Deportment of elements in the Sherritt Zinc Pressure Leach Process”, Proceedings “Zinc & Lead '95”, 22-24 May 1995, Sendai, Japan, pp 612.
6- C J Krauss, “Effects of Minor Elements on the Production of Electrolytic Zinc from Zinc Sulphide Concentrates”, Proceedings International Symposium on Extractive Metallurgy of Zinc. Tokyo, 1985, pp 467-481.
7- G L Bolton, V B Sefton, N Zubryckj, “Removal of Manganese and Chloride Ions from Aqueous Acidic Sulphate Solution”, U.S. Pat. No. 4,379,037, 1983.
8- W R Hopkins, “SX/EW: A Mature but Expending Technology”, Mining Magazine, May 1994, p. 256.
9- M L Steemson, G J Sheehan and D A Winborne, “An Integrated Bioleach/Solvent Extraction Process for Zinc Metal Production from Zinc Concentrates”, PCT Patent WO 94'28184, 1994.
10-G M Ritcey, N L Hayward and T Salinovich, “The recovery of Nickel and Cobalt from Lateritic Ores” Patent AU 4089096A1, 1996.
11-A E Norton, J J Coetzee and S C C Barnett, “An Economically Competitive Process for the Biological Extraction of Nickel”, Proceedings “ALTA 1998”: Nickel/Cobalt Pressure Leaching & Hydrometallurgy Forum, Perth, Australia, May 25-27, 1998.
12-V Nagel, “Results from the Downstream Unit Operations of an Integrated Pilot-Plant Campaign Using the BioNIC™ Process to Produce Nickel Metal Cathode at QNI's Yabulu Refinery”, Proceedings “ALTA 2000”: Nickel/Cobalt-6, Perth, Australia, May 15-18, 2000.
13-G Motteram, “Black Range Minerals Seyerston Project: A Unique Nickel Laterite”, Proceedings “ALTA 2000”: Nickel/Cobalt-6, Perth, Australia, May 15-18, 2000.
14-G Motteram, M Ryan, R Berezowsky and R Raudsepp, “Murrin Murrin Nickel/Cobalt Project: Project Development Overview”, Proceedings “ALTA 96”: Nickel/Cobalt Pressure Leaching & Hydrometallurgy Forum, Perth, Australia, May 13-14, 1996.
15-M E Calkley, R Balzan, H U Kranz and R Sánchez, “The Acid Pressure Leach Process for Nickel Cobalt Laterite: A review of Operations at Moa Nickel SA”, Proceedings “ALTA 96”: Nickel/Cobalt Pressure Leaching & Hydrometallurgy Forum, Perth, Australia, May 13-14, 1996.
16-A Griffin, “The Marlborough Laterites Project”, Proceedings “ALTA 1998”: Nickel/Cobalt Pressure Leaching & Hydrometallurgy Forum, Perth, Australia, May 25-27, 1998.
17-P Mason and M Hawker, “Ramu Nickel Process Piloting”, Proceedings “ALTA 1998”: Nickel/Cobalt Pressure Leaching & Hydrometallurgy Forum, Perth, Australia, May 25-27, 1998.
18-M G Baillie and G C Cock, “Weda Bay Laterite Project, Indonesia”, Proceedings “ALTA 1998”: Nickel/Cobalt Pressure Leaching & Hydrometallurgy Forum, Perth, Australia, May 25-27, 1998.
19-K J Hellsten and C R Lewis, “Cawse Nickel Laterite Project”, Proceedings “ALTA 96”: Nickel/Cobalt Pressure Leaching & Hydrometallurgy Forum, Perth, Australia, May 13-14, 1996.
20-T Kindred, “Cawse Nickel Operations Process Description and Production Ramp Up”, Proceedings “ALTA 2000”: Nickel/Cobalt-6, Perth, Australia, May 15-18, 2000.
21-D Jones, J Hestrin and R Moore, “CESL Process for Nickel-Cobalt-Copper Sulphides: Testing in an integrated Pilot Plant”, Proceedings “ALTA 1998”: Nickel/Cobalt Pressure Leaching & Hydrometallurgy Forum, Perth, Australia, May 25-27, 1998.
22-I O Mihaylov, E Krause, S W Laundry and C van Luong, “Process for the Extraction and Separation of Nickel and/or Cobalt”, Canadian Patent CA2145054AA, 1995.
23-J S Preston, “Solvent Extraction of Nickel and Cobalt by Mixtures of Carboxylic Acids and Non-chelating Oximes”, Hydrometallurgy, 11, 1983, p 105.
24-J S Preston and A C du Preez, “Synergistic Effects in the Solvent Extraction of Some Divalent Metals by Mixtures of Versatic 10 Acid and Pyridinecarboxylate esters”, J. Chem. Tech. Biotechnol., 61, 1994, p 159.
25-J S Preston and A C du Preez, “The Solvent Extraction of Nickel and Cobalt by Mixtures of Carboxylic Acids and Pyridinecarboxylate esters”, Solvent Extr. Ion Exch., 13, 1995, p 465.
26-J S Preston and A C du Preez, “Separation of Nickel and Calcium by Solvent Extraction Using Mixtures of Carboxylic Acids and Alkylpyridines”, Hydrometallurgy, 58, 2000, p 239.
27-M J Dry. G Ioro, D F Jacobs, P M Cole, A M Feather, K C Sole, J Engelbrecht, K C Macheft, P J Cilliers, P T O'Kane and D B Dreisinger, “Cu/Co Tailings Treatment Project, Democratic Republic of Congo”, “ALTA 1998”: Nickel/Cobalt Pressure Leaching & Hydrometallurgy Forum, Perth, Australia, May 25-27, 1998.
28-A M Feather, K C Sole and D B Dreisinger, “Pilot Plant Evaluation of Manganese Removal and Cobalt Purification by Solvent Extraction”, Proceedings “ISEC '99”: International Solvent: Extraction Conference, Barcelona, Spain, 11-16 Jul. 1999.

1. An organic solvent extraction mixture for the separation and purification of base metals from weakly acidic sulphate solutions which includes:
a. a first extractant, which is a substituted imidazole (Diagram 1) or benzimidazole (Diagram 2) 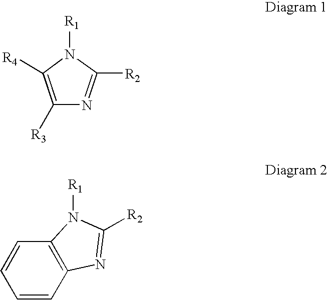
and wherein the substituents are:
—R₁=an organic group which has between 2 and 20 carbon atoms;
—R₃=a hydrogen atom or a short chain organic group with 1 or 2 carbon atoms;
—R₄=a hydrogen atom or a short chain organic group with 1 or 2 carbon atoms;
—R₂is a -methylene-1-pyrazole group, an imidazole based group, or a methylene-amino group as shown in Diagram 3 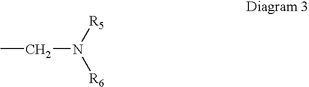
and wherein
—R₅=a hydrogen or a methyl group;
—R₆=a hydrogen or an aliphatic group containing between one and 10 carbon atoms; or
—R₆=a methylene-amino group with one of the substituents being a hydrogen or a methyl group and the other a hydrogen or an aliphatic group containing between one and 10 carbon atoms; or
—R₆=a -2-pyridine group, or
—R₆=a -methylene-1-pyrazole group, or
—R₆=a 2-methyl imidazole based group;
b. a second extractant which includes a non-selective strongly acidic sulphonic acid;
c. a modifier which is characterized by the presence of a sterically available oxygen or nitrogen atom with lone pairs of electrons; and
d. a diluent.

2. A mixture according to claim 1 wherein —R₆ is a methylene-amino group as shown in Diagram 3.

3. A mixture according to claim 1 wherein the concentration of the first extractant is between 0.01 and 1.50 Molar.

4. A mixture according to claim 1 wherein the second extractant is a sulphonic acid (R—SO₃H) and wherein R is an aliphatic group, an aromatic organic group or a mixed group consisting of aliphatic and aromatic parts, with between 3 and 40 carbon atoms.

5. A mixture according to claim 1 wherein the second extractant is selected from di-nonyl naphthalene sulphonic acid (DNNS), di-dodecyl naphthalene sulphonic acid, di-n-octyl methyl sulphonic acid and an alkyl substituted benzene sulphonic acid.

6. A mixture according to claim 4 wherein the concentration of the second extractant is between 0.001 to 1.0 Molar sulphonic acid.

7. A mixture according to claim 1 wherein the concentration of the modifier is between 10% and 70% of the mixture.

8. A mixture according to claim 1 wherein the diluent is selected from an aliphatic, aromatic or aliphatic aromatic mixture.

9. Use of the mixture of claim 1 which is carried out in the temperature range between 10° C. and 70° C. and a pH between 0 and 6.0.

10. Use according to claim 9 for the treatment of an aqueous pregnant feed solution.
